(19) United States
(12) Patent Application Publication
(10) Pub. No.: US 2015/0341239 A1
(43) Pub. Date: Nov. 26, 2015

(54) Identifying Problems In A Storage Area Network

(71) Applicant: Virtual Instruments Corporation, San Jose, CA (US)

(72) Inventors: Ana Bertran Ortiz, San Francisco, CA (US); Nicholas York, San Ramon, CA (US); Genti Cuni, Mountain View, CA (US)

(73) Assignee: Virtual Instruments Corporation, San Jose, CA (US)

(21) Appl. No.: 14/284,254

(22) Filed: May 21, 2014

(51) Int. Cl. H04L 12/26; H04L 29/08

(52) U.S. Cl. CPC H04L 43/08; H04L 67/1097

(57) ABSTRACT

For each monitored entity in a storage area network (SAN), metric data associated with the entity is collected. Based on the metric data of an entity, a determination is made as to whether the entity experienced abnormal events. For each entity for which one or more abnormal events are identified, the information system determines an aggregated event score based on the abnormal events identified for the entity. Representation of the entities are presented to a user, where the representations are ordered based on the aggregated event scores of the entities.

### CROSS-REFERENCE TO RELATED APPLICATION

This application is related to U.S. application Ser. No. 14/284,001 filed on May 21, 2014, titled “Identifying Slow Draining Devices in a Storage Area Network,” the contents of which is hereby incorporated by reference.

### BACKGROUND

1. Technical Field

The described embodiments pertain in general to data networks, and in particular to identifying entities in a storage area network affected, for example, by flow control, overutilization, severe latency and excessive queuing.

2. Description of the Related Art

A storage area network (SAN) is a data network through which servers communicate with storage devices for storing and retrieving block level data. A SAN typically includes multiple servers and storage devices connected via multiple fabrics, where each fabric includes multiple switches. The devices of a SAN are interconnected. Therefore, if one device fails or is not operating at an optimal level, it affects several other devices and the overall performance of the SAN.

Fiber Channels have no end-to-end flow control, meaning that a receiving device cannot directly slow down a sending device. In the event of a speed mismatch between devices, the receiving device must slow down the switch to which it is attached, and that switch must slow down the next device in the communication path, and so on until the sending device is slowed down. Once the sending device has been slowed down, then the flow control has been successful but every device between the sending and receiving device is now flow controlled as well. Since a SAN includes several devices, identifying the source of a network problem can be a difficult task.

### SUMMARY

The described embodiments provide methods, computer program products, and systems for providing information regarding the health of a storage area network (SAN). For each monitored entity in the SAN, metrics including traffic data of the entity are collected. Based on these metrics, a determination is made as to whether the entity experienced any abnormal events.

For each entity for which one or more abnormal events are identified, the information system determines an aggregated event score based on the abnormal events identified for the entity. The aggregated event score of an entity is a measure indicative of the degree to which one or more network problems are affecting the entity. Representations of the entities are presented to a user, where the representations are ordered based on the aggregated event scores of the entities.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of a monitored storage area network (SAN) according to one embodiment.

FIG. 2 is a block diagram illustrating an example of a network of switch fabrics according to one embodiment.

FIG. 3 is a block diagram illustrating modules within an information system according to one embodiment.

FIG. 4 is a flow diagram of a process providing information regarding the health of entities that are part of the SAN according to one embodiment.

FIG. 5 is a block diagram illustrating components of an example machine according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

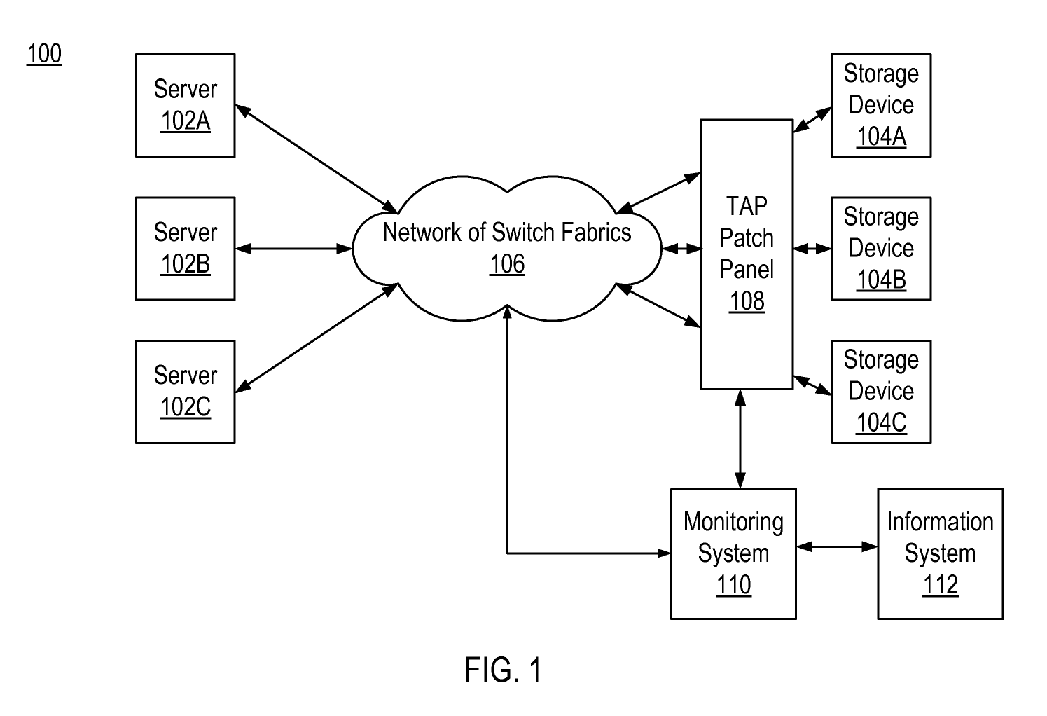

FIG. 1 is a block diagram of a monitored storage area network (SAN) 100 according to one embodiment. The SAN 100 includes three servers 102A, 102B, and 102C and three storage devices 104A, 104B, and 104C. The servers 102 and the storage devices 104 are connected via a network of switch fabrics 106. Although the illustrated SAN 100 only includes three servers 102 and three storage devices 104, other embodiments can include more of each entity.

FIG. 1 uses like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g. “102” in the text refers to reference numerals “102A,” “102B,” and/or “102C” in the figures).

A server 102 is a computing system that has access to the storage capabilities of the storage devices 104. A server 102 may provide data to a storage device 104 for storage and may retrieve stored data from a storage device 104. Therefore, a server 102 acts as a source device when providing data to a storage device 104 and acts as a destination device when requesting stored data from a storage device 104.

A storage device 104 is a storage system that stores data. In one embodiment, a storage device 104 is a disk array. In other embodiments, a storage device 104 is a tape library or an optical jukebox. When a storage device 104 receives a request from a server 102 to store data, the storage device 104 stores the data according to the request. When a storage device 104 receives a request from a server 102 for stored data, the storage device 104 retrieves the requested data and transmits it to the server 102.

The servers 102 and the storage devices 104 communicate and exchange data via the network of switch fabrics 106. The network of switch fabrics 106 includes one or more fiber channel switch fabrics. Each fabric of the network 106 includes one or more fiber channel switches that route data between devices. Several communication channels exist between the devices (e.g., servers 102, storage devices 104 and switches) included in the SAN 100. The communication channels are mediums through which signals are transported between devices. Communication channels are also referred to as “links” herein.

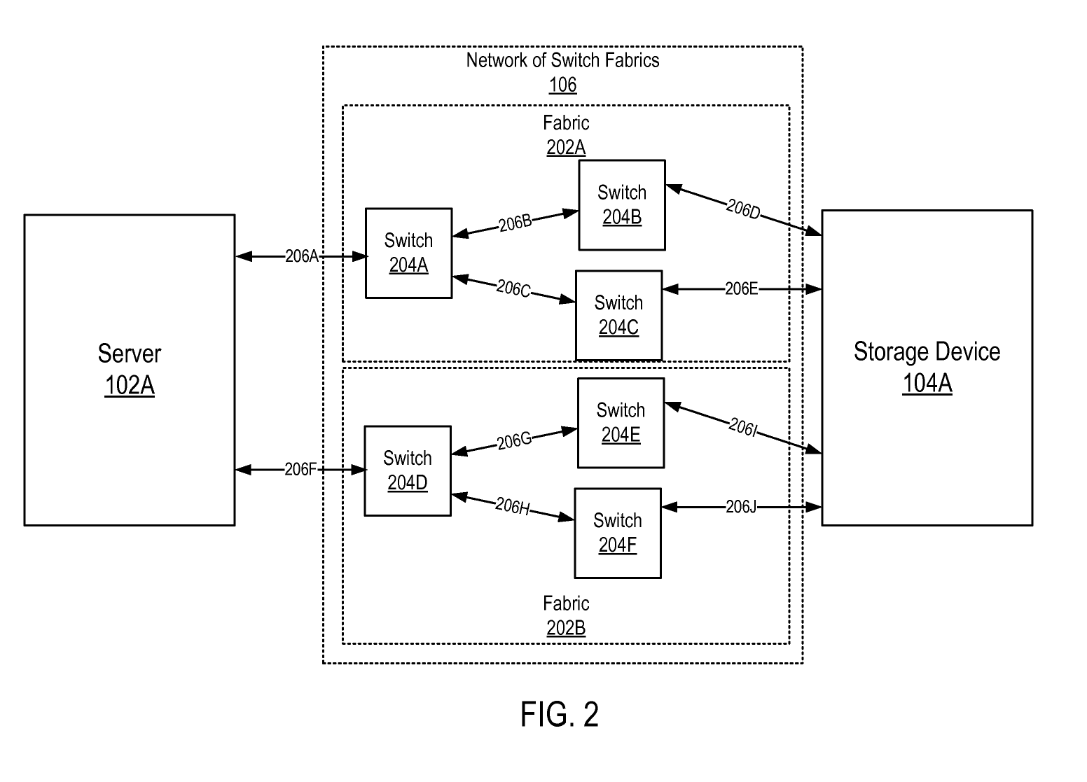

FIG. 2 illustrates an example of the network 106 and the links between server 102A and storage device 104A. In the example of FIG. 2, the network of switch fabrics 106 includes two fabrics 202A and 202B. Fabric 202A includes switches 204A, 204B, and 204C. Fabric 202B includes switches 204D, 204E, and 204F. As can be seen in FIG. 2, several links 206A-206J connect the server 102A to the storage device 104A. For example, in fabric 202A, links 206A, 206B, and 206D connect the server 102A to the storage device 104A through switches 204A and 204B. As another example, in fabric 202B, links 206F, 206H, and 206J connect the server 102A to the storage device 104A through switches 204D and 204F.

Returning to FIG. 1, the monitored SAN 100 also includes a traffic access point (TAP) patch panel 108, a monitoring system 110, and an information system 112. The TAP patch panel 108 is a hardware device inserted between the server 102 and the storage device 104. The TAP patch panel 108 diverts at least a portion of the signals being transmitted along certain links to the monitoring system 110. In one embodiment, the links for which signals are diverted are selected by a system administrator.

In one embodiment, the links in the SAN 100 are optical fibers and the network communications traveling on the optical fibers are provided via optical signals. The optical signals are converted to electrical signals at various devices (e.g., a server 102, a storage device 104, and the monitoring system 110). According to this embodiment, the TAP patch panel 108 operates by diverting for certain links a portion of light traveling on a link to an optical fiber connected to the monitoring system 110.

The monitoring system 110 is a computing system that collects metric data associated with entities in the SAN 100. In one embodiment, the monitoring system 110 is the VirtualWisdom SAN Performance Probe provided by Virtual Instruments Corporation of San Jose, Calif. The entities for which the monitoring system 110 collects metric data may be any device or component in the SAN 100, such as links, servers 102, storage devices 104, switches, ports of devices, etc.

In one embodiment, software probes run on the monitoring system 110 and utilize standard protocols to poll devices in the SAN (e.g., servers 102, storage devices 104, and switches) for available metric data of the devices, such as data that describes network traffic (referred to as “traffic data” herein), event counters, CPU and memory usage, and other types of configuration information.

Additionally, the monitoring system 110 analyzes the signals received from the TAP patch panel 108. Based on the analyzed signals, the monitoring system 110 collects (e.g., measure and/or calculates) metric data for entities in the SAN 100, including traffic data that describes network traffic on the links. The links for which the monitoring system 110 collects metric data are referred to as “monitored links” herein.

In one embodiment, for each of the monitored links, the monitoring system 110 collects traffic data that measure performance, utilization, and events of the link. Examples of traffic data that may be collected for a monitored link include: data transmission rate through the link (e.g., the average number of bits transmitted along the link per a unit time, such as megabits per second), read exchange completion time (average amount of time it takes for a read command along the link to be processed), write exchange completion time (average amount of time it takes for a write command along the link to be processed), and average input output operations per second.

Additional traffic data that may be collected for a monitored link includes a percentage of time that a device directly connected to the link spent with zero buffer-to-buffer credits. Buffer-to-buffer credits are a number of buffer slots assigned by a receiving device in the SAN 100 to a transmitting device in the SAN 100. Using the example of FIG. 2, the transmitting device may be storage device 104A and the receiving device may be switch 204B. Each time the transmitting device transmits a data frame to the receiving device, the credits are decremented by one. When the receiving device processes the data frame it sends a Receiver Ready message to the transmitting device and the transmitting device increments the credits by one.

The transmitting device can continue transmitting frames to the receiving device, even without receiving a Receiver Ready message, as long as it has credits. But if at any point the buffer-to-buffer credits reach zero, the transmitting device must stop the transmission of data in order to not overflow the receiving device's buffer. Therefore, the transmitting device will reach zero buffer credits as a result of the receiving device being delayed in processing frames and returning Receiver Ready messages. The culprit of the receiving device being delayed could be the receiving device itself or another device in the data transmission path. The culprit is referred to as a “slow draining device.” Continuing with the example of FIG. 2, the slow draining device could be, for example, switch 204A or server 102A.

In one embodiment, the monitoring system 110 associates a time with collected metric data of an entity. The time indicates when the conditions described by the metric data existed. For example, for a monitored link if the metric data is “Y megabits per second on average” and a time X is associated with the data, it signifies that at time X the average data transmission rate through the link was Y megabits per second. In one embodiment, the frequency with which the monitoring system 110 collects metric data for entities is set by a system administrator.

On a periodic basis the monitoring system 110 transmits the collected metric data to the information system 112. In one embodiment, the metric data is transmitted to the information system 112 via a local area network.

The information system 112 is a computing system that provides users with information regarding the health of the SAN 100. Upon request from a user or at a preset time, the information system 112 analyzes metric data received from the monitoring system 110 for select entities of the SAN (e.g., analyzes metric data of the monitored links) Based on the metric data, the information system 112 determines whether one or more of the entities experienced any abnormal events. An abnormal event is a signature indicative of a potential network problem. For example, an abnormal event may be indicative of there being a slow draining device in the SAN 100, exchange completion times being abnormally high, workload spikes, unusually high max pending exchanges, switch exchange completion time spikes, etc.

For each entity for which one or more abnormal events are identified, the information system 112 determines an aggregated event score. An aggregated event score is a measure indicative of the degree to which one or more network problems are affecting the entity. For example, a link with a high aggregated event score may signify that the link is being severely affected by one or more network problems (i.e., there is a high manifestation of network problems on the link).

The information system 112 determines an order for presenting the entities to a user based on each entity's aggregated event score (e.g., from highest to lowest). The information system 112 transmits information to display to the user in a user interface representations (e.g., identifiers) of the entities according to the determined order. The user interface allows the user to see which entities had the greatest manifestation of network problems and which entities should be further investigated. As part of the investigation, for each entity, the user can analyze through the user interface the metric data associated with each identified abnormal event in order to potentially diagnose the network problems affecting the entity and the source of these problems.

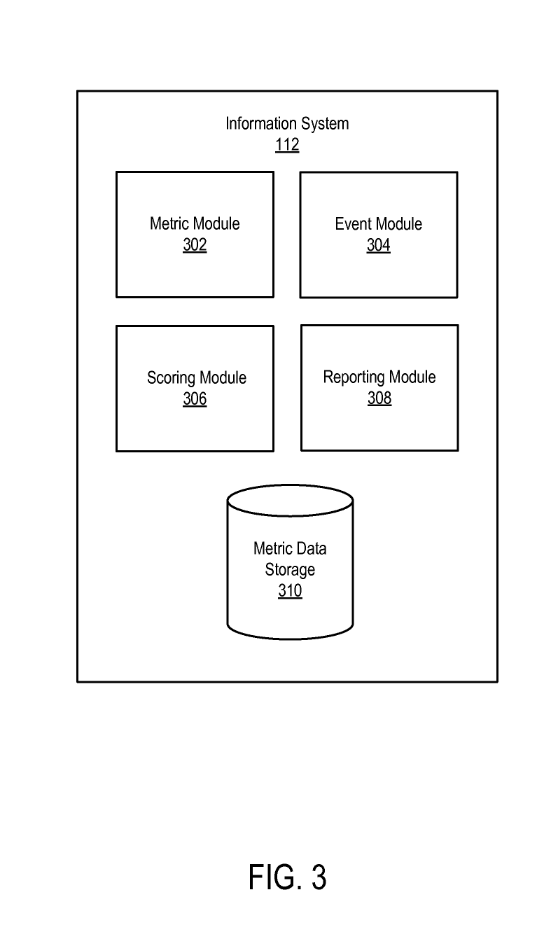

FIG. 3 is a block diagram illustrating modules within the information system 112 according to one embodiment. The information system 112 includes a metric module 302, a event module 304, a scoring module 306, a reporting module 308, and a metric data storage 310. Those of skill in the art will recognize that other embodiments can have different and/or other modules than the ones described here, and that the functionalities can be distributed among the modules in a different manner.

The metric module 302 processes metric data received from the monitoring system 110. In one embodiment, when metric data of an entity is received from the monitoring system 110, the metric module 302 stores the data in the metric data storage 310. Based on the storing of the data received from the monitoring system 110, for each monitored entity the metric data storage 314 includes various data points at various times. For example, for each monitored link, the metric data storage 314 may include for every hour the data transfer rate of the link and the percentage of time during the hour that a device connected to the link spent with zero buffer-to-buffer credits.

The event module 304 initiates a process of determining health characteristics of the SAN 100. In one embodiment, the process is initiated when a request is received from a user (e.g., a system administrator) to perform the process. In one embodiment, the process is initiated periodically (e.g., once a week) at a preset time. The process specifically involves identifying abnormal events of entities, weighing the abnormal events, and scoring the entities based on the identified abnormal events.

As part of the process, for multiple entities, the event module 304 retrieves, from the metric data storage 310, metric data of a specific metric and associated with times that are within a certain time period. For example, for each monitored link the path module 304 may retrieve percentage of time with zero buffer-to-buffer credits values stored in the metric data storage 314 that are associated with times within the past 36 hours. Based on the data retrieval from the metric data storage 314, a data series is identified for each of the multiple entities which includes multiple data points.

The entities for which metric data is retrieved, the specific type of metric data retrieved and the time span that the metric data must fall within may be preset or indicated by a user initiating the process. The specific type of metric data retrieved allows for the identification of abnormal events indicative of specific network problems. For example, data for percentage of time with zero buffer-to-buffer credits allows for the identification of abnormal events indicative of there being a slow draining device in the SAN 100. Other types of network problems that can be identified include spikes in response times to perform a unit of work (which may be matched, for example, with a change in request size or a change in number of requests), a spike in CPU utilization of a server 102 (which may be matched, for example, with an increase in workload on a single virtual machine running on the server 102), a spike in an application (which can be used to identify the individual hosts in the application that generated the additional workload), and a spike in a storage device's response time (which can be used to identify the conversation(s) or server 102 that caused the spike or were affected).

For each entity for which metric data is retrieved, the event module 304 groups data points of the entity's data series that satisfy certain criteria. In one embodiment, the event module 304 groups data points that are above a threshold (above threshold data points) where no above threshold data point is separated from another above threshold data point in the series by more than a set number of consecutive below threshold data points (data points below the threshold). Each created group of data points is an identified abnormal event.

In one embodiment, to group data points/identify abnormal events, the event module 304 starts at the beginning of the data series and identifies the first data point above the threshold. The event module 304 then continues through the data series until it identifies a set number of consecutive data points in the series that are below the threshold (e.g., three consecutive below threshold data points). The event module 304 includes in a first group the first data point identified above the threshold and the data point (referred to as the “last group data point”) in the series immediately prior to the first of the consecutive below threshold data points. The event module 304 also includes in the first group any data points between the first data point and the last group data point in the series. The event module 304 continues through the data series and repeats the process to potentially create additional groups.

As an example of identifying abnormal events, assume the data series includes the following data point values: 3, 2, 15, 20, 2, 11, 5, 4, 6, 12, 13, 2, 3, 5. Further assume that the threshold is 7 and that in a group an above threshold data point cannot be separated from another above threshold data point by more than 2 data points in the series. In this example, two abnormal events are identified. The first abnormal event includes data points 15, 20, 2, and 11. The first abnormal event starts with 15 because it is the first data point in the series above the threshold. The first abnormal event ends after 11 because of the 5, 4, 6 values after the 11 are three consecutive data points below the threshold. The second abnormal event includes data points 12 and 13. The second abnormal event starts with 12 because it is the first data point above the threshold after the first event. The second abnormal event ends after the 13 because 2, 3, and 5 are each below the threshold.

In one embodiment, the threshold and the set number for separating groups is set, for example, based on the exploration of hundreds of terabytes of data from the world's largest storage infrastructures. In one embodiment, the threshold and set number vary depending on the specific type of metric data retrieved by the event module 304. For example, the threshold for zero buffer-to-buffer credits may be different than the threshold for exchange completion times.

In one embodiment, for each identified abnormal event of an entity, the event module 304 determines a start time and an end time for the abnormal event. Initially, the event module 304 determines that the start time is the time associated with first data point of the event and the end time is the time associated with the last data point of the event. The event module 304 then determines whether it necessary to adjust the start and end times by analyzing the data series of the entity.

For the start time, the event module 304 determines whether the data point in the series immediately prior to the first data point of the event is greater than the first data point. If the prior data point is greater than the first data point, the event module 304 determines that no adjustment to the start time is necessary. If the prior data point is less than the first data point, the event module 304 adjusts the start time because it signifies that the current start time is not a valley of the series. The event module 304 adjusts the start time to be the time associated with the next data point in the data series that precedes the first data point (the next proceeding data point) where the data point that immediately precedes it is greater than its own value.

Continuing with the data series example from above, for the first abnormal event that includes data points 15, 20, and 11, the start time for the first event would initially be the time associated with data point 15. However, since the data point 2, which precedes data point 15 in the series, is less than data point 15 but greater than data point 3, the even module 304 would adjust the start time to be the time associated with data point 2.

For the end time, the event module 304 determines whether the data point in the series immediately after the last data point of the event is greater than the first data point. If the next data point is greater than the last data point, the event module 304 determines that no adjustment to the end time is necessary. However, if the next data point is less than the last data point, the event module 304 adjusts the end time because the current end time is not a valley of the series. The event module 304 adjusts the end time to be the time associated with the subsequent data point in the data series that is after the last data point (the subsequent data point) where the data point that is immediately after it is greater than its own value.

Further continuing with the data series example from above, where the first abnormal event that includes data points 15, 20, and 11, the end time for the first event would initially be the time associated with data point 11. However, since data point 5, which is immediately after data point 11 in the series, is less than data point 11, the end time is adjusted. The event module 304 would adjust the end time to be the time associated with data point 4 since data point 6 after it is greater than data point 4.

In one embodiment, for each identified abnormal event of an entity, the event module 304 additionally determines a length of the abnormal event. The event module 304 determines the length of each abnormal event to be the difference between the event's start and end times.

The scoring module 306 determines aggregated event scores for the entities. For each entity for which one or more abnormal events were identified by the event module 304, the scoring module 306 determines an aggregated event score based on the abnormal events identified for the entity. As described above, the aggregated event score of an event is a measure indicative of the degree to which one or more network problems are affecting the entity.

To determine the aggregated event score of an entity, the scoring module 306 calculates a weighted score for each abnormal event identified by the event module 304 for the entity. The scoring module 306 calculates the weighted score of an abnormal event by weighing the event's data points. In one embodiment, to calculate the weighted score of an abnormal event, the scoring module 306 identifies the data points of the event (i.e., the grouped data points), multiplies the value of each data point by a weighted value, and sums the weighted data point values. In one embodiment, the weighted value used with each data point value varies depending on the data point value. For example, assume the data point values are percentages of time spent with zero buffer credits. In this specific embodiment, assume if the data point value is below 20%, the data point value is not taken into account in calculating the weighted score of the event. In other words, the data point value is multiplied by a weight value of zero. On the other hand, if the data point value is 20% or greater, the value gets weighed by a weight value that varies linearly from 1 at 20% to 10 at 100%. In other words, if the data point value is 20% or greater, the data point gets multiplied by a weight value equal to 1+0.1125(X−20), where X is the data point value. Therefore, in this example if the event's data points have values of 8, 40, and 20, the weighted score of the event would be equal to: (40×3.25)+(20×1).

In another embodiment, each data point is multiplied by the same weighted value. In one embodiment, the one or more weighted values used in determining the weighted scores of the abnormal events vary depending on the specific type of metric data retrieved by the event module 304 to identify the events. For example, the weight values used on data transmission rate values may be different than those used for zero buffer credit values.

The scoring module 306 determines the aggregated event score of the entity based on the weighted scores of the entity's abnormal events. In one embodiment, the scoring module 306 determines the aggregated event score to be the sum of the events' weighted scores. In another embodiment, the scoring module 306 determines the aggregated event score to be equal to highest weighted score determined for the events. The scoring module 306 stores the aggregated event score determined for the entity in the metric data storage 310.

The reporting module 308 notifies users of determinations made by the information system 112 with regards to the health of the entities in the SAN 100. In one embodiment, when the information system 112 receives a request from a user device (e.g., device of a system administrator) for information regarding the health of entities in the SAN 100, the reporting module 308 determines an order for presenting representations of the entities for which the scoring module 306 calculates an aggregated event score. The reporting module 308 determines the order based on each entity's aggregated event score. In one embodiment, the order is from highest aggregated event score to lowest aggregated event score. In one embodiment, the reporting module 308 selects from entities a set number of entities to present based on entities' aggregated event scores. For example, the reporting module 308 may select the entities with ten highest aggregated features scores. The reporting module 308 provides a user interface to the user device that includes the representations of the selected entities. The representations are presented according to the determined order.

For each entity, the reporting module 308 calculates a severity score based on entity's aggregated event score with respect to the highest calculated aggregated event score among the entities. In one embodiment, the severity score of an entity is equal to the entity's aggregated event score divided by the highest entity aggregated event score calculated by the scoring module 306 for an entity. Therefore, in this embodiment, the entity with the highest aggregated event score will have a severity score of one and the other entities will have severity scores that are below one.

With each representation of an entity, the user interface includes one or more of the following: the severity score of the entity, the number of abnormal events identified by the event module 304 for the entity, the length of the longest identified abnormal event, the aggregated length of the identified abnormal events, the highest weighted scores calculated for the identified abnormal events, and the aggregated event score of the entity.

Through the user interface the user can see which entities have the greatest manifestation of network problems and can concentrate his attention on those entities. Through the user interface, the user can further request information as to the abnormal events identified for each entity. When the user makes such a request for a specific entity, the user interface is updated by the reporting module 308 to include for each identified abnormal event the data points of the event. Through the data of the abnormal events, the user can potentially diagnose one or more network problems affecting the entity and identify potential sources for the problems. The sources of the network problems can also be determined in an automated fashion as described, for example, in related application U.S. application Ser. No. ______, titled “Identifying Slow Draining Devices in a Storage Area Network.” It should be understood that the information described as being accessible through the user interface may also be included in a report transmitted to a user, for example, via email.

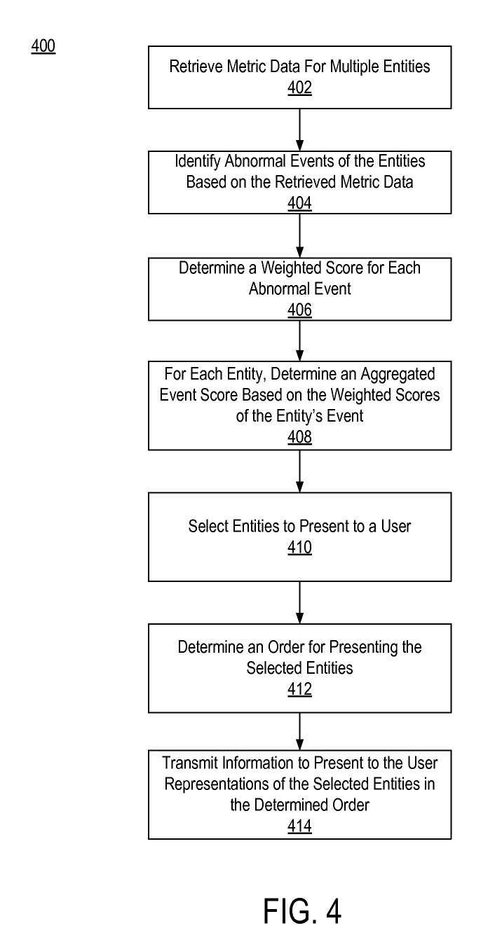

FIG. 4 is a flow diagram of a process 400 performed by the information system 112 for providing information regarding the health of entities that are part of the SAN 100 according to one embodiment. Those of skill in the art will recognize that other embodiments can perform the steps of FIG. 4 in different orders. Moreover, other embodiments can include different and/or additional steps than the ones described herein.

The information system 112 retrieves 402 for multiple entities, metric data associated with the entities (e.g., retrieves traffic data for each monitored link) For one or more of the entities, the information system 112 identifies 404 one or more abnormal events of the entity. Each abnormal event has certain metric data associated with it (i.e., each abnormal event includes grouped data points). For each abnormal event identified for an entity, the information system 112 determines 406 a weighted score and length based on the metric data associated with the event.

For each entity for which one or more events were identified, the information system 112 determines 408 an aggregated event score for the entity. An entity's aggregated event score is determined based on the weighted score of each abnormal event identified for the entity. The information system 112 selects 410 a set number of entities to present to a user based on each entity's aggregated event score. For example, the information system 112 may select the entities with top 10 aggregated event scores. The information system 112 determines 412 an order for presenting the selected entities based on each entity's aggregated event score. The information system 112 transmits 414 information to a user device to present representations of the selected entities in the determined order to the user.

Although the processes of identifying abnormal events and scoring entities has been described in a storage area network environment, it should be understood that the processes can be applied to other network environments.

### Computing Machine Architecture

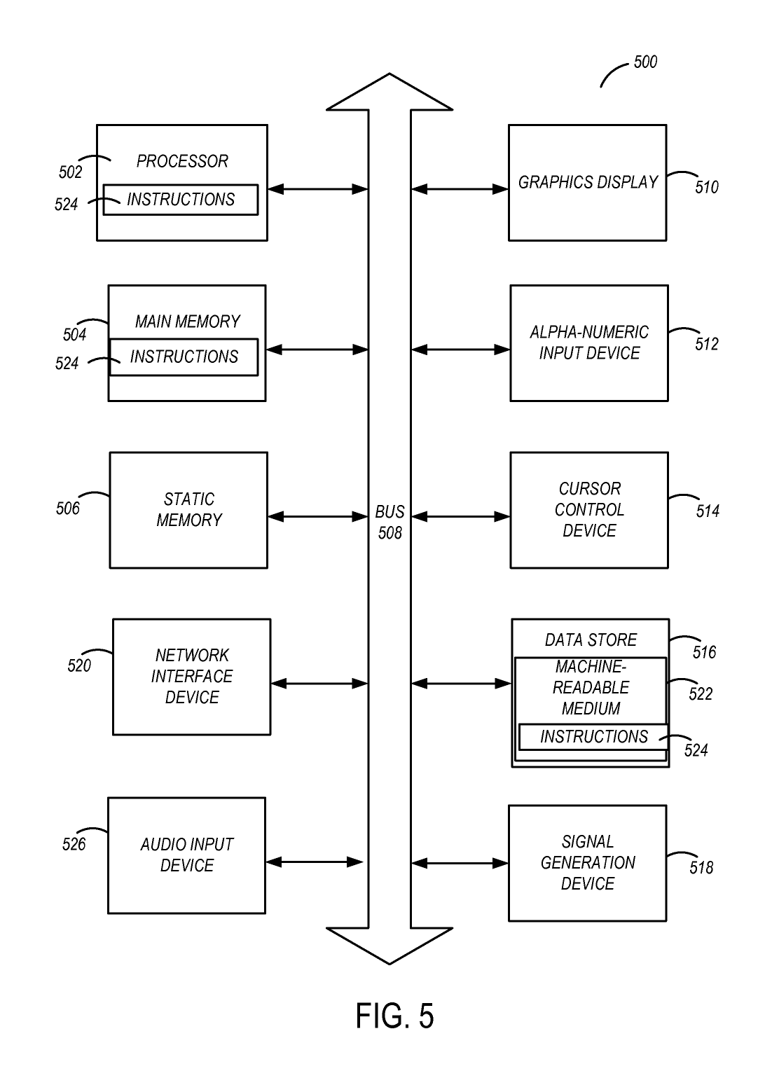

FIG. 5 is a block diagram illustrating components of an example machine able to read instructions from a non-transitory machine-readable medium and execute those instructions in a processor to perform the machine processing tasks discussed herein, such as the operations discussed above for the servers 102, the storage devices 104, the TAP patch panel 108, the monitoring system 110, and the information system 112. Specifically, FIG. 5 shows a diagrammatic representation of a machine in the example form of a computer system 500 within which instructions 524 (e.g., software) for causing the machine to perform any one or more of the methodologies discussed herein may be executed. In alternative embodiments, the machine operates as a standalone device or may be connected (e.g., networked) to other machines, for instance via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a data store 516, a signal generation device 518 (e.g., a speaker), an audio input device 526 (e.g., a microphone) and a network interface device 520, which also are configured to communicate via the bus 508.

The data store 516 includes a non-transitory machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (not shown) via network interface 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 5. Alternatively, hardware or software modules may be stored elsewhere within a computing system.

As referenced herein, a computer or computing system includes hardware elements used for the operations described here regardless of specific reference in FIG. 5 to such elements, including for example one or more processors, high speed memory, hard disk storage and backup, network interfaces and protocols, input devices for data entry, and output devices for display, printing, or other presentations of data. Numerous variations from the system architecture specified herein are possible. The components of such systems and their respective functionalities can be combined or redistributed.

### ADDITIONAL CONSIDERATIONS

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

It is appreciated that the particular embodiment depicted in the figures represents but one choice of implementation. Other choices would be clear and equally feasible to those of skill in the art.

While the disclosure herein has been particularly shown and described with reference to a specific embodiment and various alternate embodiments, it will be understood by persons skilled in the relevant art that various changes in form and details can be made therein without departing from the spirit and scope of the disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience. This description should be read to include one or at least one and the singular also includes the plural unless it is obvious that it is meant otherwise.

Upon reading this disclosure, those of skill in the art will appreciate still additional alternative structural and functional designs for identifying network problems through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
for one or more links in a storage area network:
identifying metric data associated with the link;
identifying one or more abnormal events of the link based on the identified metric data;
determining for each abnormal event a weighted score based on metric data associated with the event; and
determining an aggregated event score for the link based on the weighted score determined for an identified abnormal event, the aggregated event score indicative of a degree in which one or more network problems are affecting the link;
selecting from the links for which an aggregated event score is determined, a set number of links based on the aggregated event score determined for each selected link; and
transmitting instructions to display representations of the selected links, the representations ordered based on the aggregated event score determined for each of the selected links.

2. The method of claim 1, further comprising:
responsive to receiving a request for event information associated with a selected link, transmitting information to display metric data associated with an abnormal event of the selected link.

3. A computer-implemented method comprising:
identifying metric data associated with an entity in a network;
identifying an abnormal event of the entity based on the identified metric data, the abnormal event a signature indicative of a network problem;
determining an aggregated event score for the entity based on the abnormal event, the score indicative of a degree in which one or more network problems are affecting the entity; and
storing the aggregated event score.

4. The method of claim 3, wherein the network is a storage area network.

5. The method of claim 3, wherein the metric data includes a series of data points and identifying the abnormal event comprises identifying data points from the series that are above a threshold.

6. The method of claim 5, wherein the series includes below threshold data points that are below the threshold and each identified data point is not separated from another identified data point in the series by more than a set number of consecutive below threshold data points.

7. The method of claim 3, wherein determining the aggregated event score comprises:
determining a weighted score for the abnormal event based on metric data associated with the abnormal event; and
determining the aggregated event score based on the weighted score determined for the abnormal event and weighted scores determined for additional abnormal events identified for the entity.

8. The method of claim 7, wherein the metric data associated with the abnormal event includes a plurality of data points and the weighted score is determined based on values of the plurality of data points and one or more weight values.

9. The method of claim 7, wherein the metric data associated with the abnormal event includes a plurality of data points and determining the weighted score comprises:
summing values of the plurality of data points, each value multiplied by a weight value prior to the summation.

10. A computer program product stored on a non-transitory computer-readable storage medium having computer-executable instructions, the computer program product comprising:
a event module configured to:
identify metric data associated with an entity in a network;
identify an abnormal event of the entity based on the identified metric data, the abnormal event a signature indicative of a network problem; and
a scoring module configured to:
determine an aggregated event score for the entity based on the abnormal event, the score indicative of a degree in which one or more network problems are affecting the entity; and
store the aggregated event score.

11. The computer program product of claim 10, wherein the network is a storage area network.

12. The computer program product of claim 10, wherein the metric data includes a series of data points and the event module is further configured to identify data points from the series that are above a threshold.

13. The computer program product of claim 12, wherein the series includes below threshold data points that are below the threshold and each identified data point is not separated from another identified data point in the series by more than a set number of consecutive below threshold data points.

14. The computer program product of claim 10, wherein the scoring module is further configured to:
determine a weighted score for the abnormal event based on metric data associated with the abnormal event; and
determine the aggregated event score based on the weighted score determined for the abnormal event and weighted scores determined for additional abnormal events identified for the entity.

15. The computer program product of claim 14, wherein the metric data associated with the abnormal event includes a plurality of data points and the weighted score is determined based on values of the plurality of data points and one or more weight values.

16. The computer program product of claim 14, wherein the metric data associated with the abnormal event includes a plurality of data points and the scoring module is further configured to:
sum values of the plurality of data points, each value multiplied by a weight value prior to the summation.

17. A computer system comprising:
one or more computer processors; and
a non-transitory computer-readable storage medium storing modules adapted to execute on the one or more processors, the modules comprising:
a event module configured to:
identify metric data associated with an entity in a network;
identify an abnormal event of the entity based on the identified metric data, the abnormal event a signature indicative of a network problem; and
a scoring module configured to:
determine an aggregated event score for the entity based on the abnormal event, the score indicative of a degree in which one or more network problems are affecting the entity; and
store the aggregated event score.

18. The system of claim 17, wherein the metric data includes a series of data points and the event module is further configured to identify data points from the series that are above a threshold.

19. The system of claim 18, wherein the series includes below threshold data points that are below the threshold and each identified data point is not separated from another identified data point in the series by more than a set number of consecutive below threshold data points.

20. The system of claim 17, wherein the scoring module is further configured to:
determine a weighted score for the abnormal event based on metric data associated with the abnormal event; and
determine the aggregated event score based on the weighted score determined for the abnormal event and weighted scores determined for additional abnormal events identified for the entity.
